(19) United States
(12) Patent Application Publication
(10) Pub. No.: US 2016/0306202 A1
(43) Pub. Date: Oct. 20, 2016

(54) LIQUID CRYSTAL DISPLAY

(71) Applicant: Samsung Display Co., Ltd., Yongin-City (KR)

(72) Inventors: Cheol-Gon LEE, Seoul (KR); Kwang-Chul JUNG, Seongnam-si (KR); Jang Mi KANG, Bucheon-si (KR); Mee Hye JUNG, Suwon-si (KR)

(21) Appl. No.: 14/863,271

(22) Filed: Sep. 23, 2015

(30) Foreign Application Priority Data
Apr. 16, 2015 (KR) 10-2015-0053840

(51) Int. Cl. G02F 1/137; G02F 1/1362; G02F 1/1343

(52) U.S. Cl. CPC G02F 1/137; G02F 1/134309; G02F 1/136286; G02F 2001/134345

(57) ABSTRACT

The present inventive concept relates to a liquid crystal display which includes a substrate; a first gate line; a first data line and a second data line applied with a data voltage of different polarities; a first pixel electrode connected to the first gate line and the first data line; a second pixel electrode connected to the first gate line and the second data line; a liquid crystal layer; a first common electrode applied with a first voltage; and a second common electrode applied with a second voltage different from the first voltage, wherein the first pixel electrode includes a first subpixel electrode overlapping the first common electrode and a second subpixel electrode overlapping the second common electrode, and the second pixel electrode includes a third subpixel electrode overlapping the second common electrode and a fourth subpixel electrode overlapping the first common electrode.

### CROSS-REFERENCE TO RELATED APPLICATION

This application claims priority to and the benefit of Korean Patent Application No. 10-2015-0053840 filed in the Korean Intellectual Property Office on Apr. 16, 2015, the entire contents of which are incorporated herein by reference.

### BACKGROUND

(a) Technical Field

The present inventive concept relates to a liquid crystal display. More particularly, the present inventive concept relates to a liquid crystal display improving lateral visibility.

(b) Description of the Related Art

Liquid crystal displays, the most popular type of flat panel display, are composed of two display panels with field generating electrodes, such as a pixel electrode and a common electrode, and a liquid crystal layer between the display panels, and they display images by generating an electric field when voltage is applied to the field generating electrodes such that the liquid crystal molecules in the liquid crystal layer are aligned to control polarization of incident light.

Two display panels constituting the liquid crystal display may include a thin film transistor array panel and a facing display panel. A gate line to transmit a gate signal and a data line to transmit a data signal may be formed on the thin film transistor array panel so as to intersect each other. A thin film transistor connected to the gate line and the data line, a pixel electrode connected to the thin film transistor, and the like, may be formed on the thin film transistor array panel. A light blocking member, a color filter, a common electrode, and the like, may be formed on the facing display panel. If necessary, the light blocking member, the color filter, and the common electrode may also be formed on the thin film transistor array panel.

Among liquid crystal displays, when the electric field is not applied, a vertical alignment mode liquid crystal display, in which liquid crystal molecules are arranged so that a long axis thereof is vertical to the display panel when no electric field is applied, has a large contrast ratio and a wide reference viewing angle, and thus the vertical alignment mode liquid crystal display has received much attention. Here, the reference viewing angle means a luminance inversion critical angle between viewing angles or grays which have the contrast ratio of 1:10.

In the case of the vertical alignment mode liquid crystal display, in order that lateral visibility be close to front visibility, a method is proposed in which one pixel is divided into two subpixels, voltages of the two subpixels are different from each other, such that transmittances thereof are different from each other. In this case, complicated circuits are required to differentiate the voltages of two subpixels and, as a result, the manufacturing cost is increased.

The above information disclosed in this Background section is only to enhance the understanding of the background of the inventive concept, and therefore it may contain information that does not form the prior art.

### SUMMARY

The present inventive concept provides a liquid crystal display capable of improving lateral visibility.

A liquid crystal display according to an exemplary embodiment of the present inventive concept includes a substrate; a first gate line disposed on the substrate; a first data line and a second data line disposed on the substrate and applied with a data voltage having different polarities; a first pixel electrode connected to the first gate line and the first data line; a second pixel electrode connected to the first gate line and the second data line; a liquid crystal layer disposed on the first pixel electrode and the second pixel electrode; a first common electrode disposed on the liquid crystal layer and applied with a first voltage; and a second common electrode disposed on the liquid crystal layer and applied with a second voltage different from the first voltage, wherein the first pixel electrode includes a first subpixel electrode overlapping the first common electrode and a second subpixel electrode overlapping the second common electrode, and the second pixel electrode includes a third subpixel electrode overlapping the second common electrode and a fourth subpixel electrode overlapping the first common electrode.

The first subpixel electrode and the second subpixel electrode may be connected to each other, and the third subpixel electrode and the fourth subpixel electrode may be connected to each other.

The second voltage may be higher than the first voltage, the data voltage having positive polarity may be applied to the first pixel electrode, and the data voltage having negative polarity may be applied to the second pixel electrode.

The first voltage and the second voltage may be alternately applied to the first common electrode and the second common electrode, the second voltage may be applied to the second common electrode when the first common electrode is applied with the first voltage, and the second common electrode maybe applied with the first voltage when the first common electrode is applied with the second voltage.

The second voltage may be higher than the first voltage when the first common electrode is applied with the first voltage and the second common electrode is applied with the second voltage, and the data voltage having positive polarity may be applied to the first pixel electrode and the data voltage having negative polarity may be applied to the second pixel electrode.

When the first common electrode is applied with the second voltage and the second common electrode is applied with the first voltage, the data voltage having negative polarity may be applied to the first pixel electrode and the data voltage having positive polarity may be applied to the second pixel electrode.

Timing for changing the common voltage applied to the first common electrode is determined depending on a timing for applying a gate signal to the first gate line.

Timing for changing the common voltage applied to the first common electrode is synchronized with a timing for applying a gate-on voltage to the first gate line.

The liquid crystal display may include a plurality of first common electrodes and a plurality of first gate lines, the plurality of first gate lines may be sequentially applied with gate-on voltages, and the timing for changing the common voltage applied to the plurality of first common electrodes is determined depending on a timing for applying the signal to the first gate line adjacent to each first common electrode.

The timing for changing the common voltage applied to the plurality of first common electrodes is synchronized with a timing for applying a gate-on voltage to each first gate line adjacent to each first common electrode.

The liquid crystal display according to an exemplary embodiment of the present inventive concept may further a second gate line disposed on the substrate;

a third data line disposed on the substrate and applied with the data voltage having the same polarity as the first data line; a third pixel electrode connected to the second gate line and the second data line; and a fourth pixel electrode connected to the second gate line and the third data line, wherein the third pixel electrode includes a fifth subpixel electrode overlapping the second common electrode and a sixth subpixel electrode overlapping the first common electrode, and the fourth pixel electrode includes a seventh subpixel electrode overlapping the first common electrode and an eighth subpixel electrode overlapping the second common electrode.

The fifth subpixel electrode and the sixth subpixel electrode may be connected to each other, and the seventh subpixel electrode and the eighth subpixel electrode may be connected to each other.

The second voltage may be higher than the first voltage, the data voltage having positive polarity may be applied to the first pixel electrode and the fourth pixel electrode, and the data voltage having negative polarity may be applied to the second pixel electrode and the third pixel electrode.

The first voltage and the second voltage may be alternately applied to the first common electrode and the second common electrode, the second voltage may be applied to the second common electrode when the first voltage is applied to the first common electrode, and the first voltage may be applied to the second common electrode when the second voltage is applied to the first common electrode.

The second voltage may be higher than the first voltage when the first voltage is applied to the first common electrode and the second voltage is applied to the second common electrode, and the data voltage having positive polarity may be applied to the first pixel electrode and the fourth pixel electrode and the data voltage having negative polarity may be applied to the second pixel electrode and the third pixel electrode.

When the second voltage is applied to the first common electrode and the first voltage is applied to the second common electrode, the data voltage having negative polarity may be applied to the first pixel electrode and the fourth pixel electrode, and the data voltage having positive polarity may be applied to the second pixel electrode and the third pixel electrode.

The liquid crystal display according to an exemplary embodiment of the present inventive concept further includes a first common electrode line and a second common electrode line disposed on the substrate, the first common electrode line may be connected to the first common electrode, and the second common electrode line may be connected to the second common electrode.

The first common electrode line and the second common electrode line may be disposed on the same layer as the gate line.

The liquid crystal display according to an exemplary embodiment of the present inventive concept may further include a roof layer disposed on the first common electrode and the second common electrode and an encapsulation layer disposed on the roof layer.

The liquid crystal display according to an exemplary embodiment of the present inventive concept may further include a plurality of microcavities, of which an upper surface and a side surface are covered by the roof layer and the encapsulation layer, and the liquid crystal layer is disposed in the plurality of microcavities.

The liquid crystal display according to an exemplary embodiment of the present inventive concept has following effects.

In the liquid crystal display according to an exemplary embodiment of the present inventive concept, two subpixels overlap two common electrodes transmitting different voltages to differentiate the transmittance of two subpixels, thereby improving lateral visibility.

### BRIEF DESCRIPTION OF THE DRAWINGS

FIG. 1 is an equivalent circuit diagram of a display device according to an exemplary embodiment of the present inventive concept.

FIG. 2 is a view showing a data voltage Vd transmitted through each data line and a common voltage applied to a common electrode.

FIG. 3 and FIG. 4 are views showing a polarity of a data voltage Vd applied to each pixel of a liquid crystal display according to an exemplary embodiment of the present inventive concept.

FIG. 5 is a layout view of a portion of a liquid crystal display according to an exemplary embodiment of the present inventive concept.

FIG. 6 is a cross-sectional view of a liquid crystal display according to an exemplary embodiment of the present inventive concept of FIG. 5 taken along line VI-VI.

FIG. 7 is a cross-sectional view of a liquid crystal display according to an exemplary embodiment of the present inventive concept of FIG. 5 taken along line VII-VII.

FIG. 8 is a cross-sectional view of a liquid crystal display according to an exemplary embodiment of the present inventive concept of FIG. 5 taken along line VIII-VIII.

FIG. 9 is a layout view of a portion of a liquid crystal display according to an exemplary embodiment of the present inventive concept.

FIG. 10 is a cross-sectional view of a liquid crystal display according to an exemplary embodiment of the present inventive concept of FIG. 9 taken along line X-X.

FIG. 11 is a cross-sectional view of a liquid crystal display according to an exemplary embodiment of the present inventive concept of FIG. 9 taken along line XI-XI.

FIG. 12 is a cross-sectional view of a liquid crystal display according to an exemplary embodiment of the present inventive concept of FIG. 9 taken along line XII-XII.

FIG. 13 is a timing diagram of a signal applied to a liquid crystal display according to an exemplary embodiment of the present inventive concept.

### DETAILED DESCRIPTION OF THE EMBODIMENTS

The present inventive concept will be described more fully hereinafter with reference to the accompanying drawings, in which exemplary embodiments of the inventive concept are shown. As those skilled in the art would realize, the described embodiments may be modified in various different ways, all without departing from the spirit or scope of the present inventive concept.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

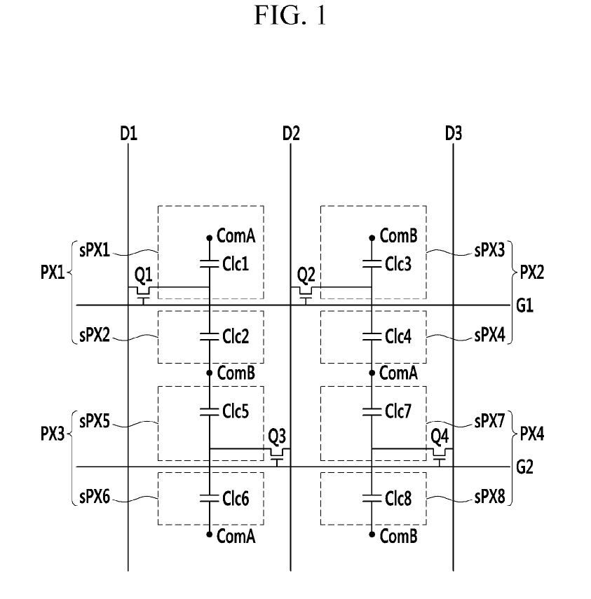

First, a liquid crystal display according to an exemplary embodiment of the present inventive concept will be described with reference to FIG. 1.

FIG. 1 is an equivalent circuit diagram of a display device according to an exemplary embodiment of the present inventive concept.

A display device according to an exemplary embodiment of the present inventive concept includes a first gate line G1, a first data line D1, a second data line D2, and a first pixel PX1 and a second pixel PX2 connected thereto.

The first gate line G1 transmits a gate signal and the gate signal may include a gate-on voltage and a gate-off voltage. The first data line D1 and the second data line D2 transmit the data voltage, and the polarities of the data voltage applied to the first data line D1 and the data voltage applied to the second data line D2 may be different. For example, when the first data line D1 is applied with a data voltage having a positive polarity, the second data line D2 is applied with a data voltage having a negative polarity. In contrast, when the first data line D1 is applied with a data voltage having a negative polarity, the second data line D2 is applied with a data voltage having a positive polarity.

A first thin film transistor Q1 connected to the first gate line G1 and the first data line D1 and a second thin film transistor Q2 connected to the first gate line G1 and the second data line D2 are formed.

The first pixel PX1 includes a first subpixel sPX1 and a second subpixel sPX2, and a second pixel PX2 includes a third subpixel sPX3 and a fourth subpixel sPX4.

A first liquid crystal capacitor Clc1 connected to the first thin film transistor Q1 is formed in the first subpixel sPX1 and a second liquid crystal capacitor Clc2 connected to the first thin film transistor Q1 is formed in the second subpixel sPX2.

The first liquid crystal capacitor Clc1 is connected to the first common electrode ComA, and the second liquid crystal capacitor Clc2 is connected to the second common electrode ComB. The first common electrode ComA and the second common electrode ComB are applied with different voltages. For example, when the first common electrode ComA is applied with a first voltage, the second common electrode ComB is applied with a second voltage. In contrast, when the first common electrode ComA is applied with a second voltage, the second common electrode ComB is applied with a first voltage.

A third liquid crystal capacitor Clc3 connected to the second thin film transistor Q2 is formed in the third subpixel sPX3, and a fourth liquid crystal capacitor Clc4 connected to the second thin film transistor Q2 is formed in the fourth subpixel sPX4.

The third liquid crystal capacitor Clc3 is connected to the second common electrode ComB, and the fourth liquid crystal capacitor Clc4 is connected to the first common electrode ComA.

The display device according to an exemplary embodiment of the present inventive concept may further include a second gate line G2, a third data line D3, and a third pixel PX3 and a fourth pixel PX4 connected thereto.

The second gate line G2 transmits the gate signal and the gate signal may include the gate-on voltage and the gate-off voltage. The timing for when the second gate line G2 is applied with the gate-on voltage and the timing for when the first gate line G1 is applied with the gate-on voltage may be different. After the first gate line G1 is first applied with the gate-on voltage, the second gate line G2 may be applied with the gate-on voltage.

The third data line D3 transmits the data voltage, and the polarities of the data voltage applied to the third data line D3 and the data voltage applied to the first data line D1 are equal to each other. The polarities of the data voltage applied to the third data line D3 and the data voltage applied to the second data line D2 are different. For example, when a data voltage having positive polarity is applied to the first data line D1 and the third data line D3, a data voltage having negative polarity is applied to the second data line D2.

A third thin film transistor Q3 connected to the second gate line G2 and the second data line D2 is formed and a fourth thin film transistor Q4 connected to the second gate line G2 and the third data line D3 is formed.

The third pixel PX3 includes a fifth subpixel sPX5 and a sixth subpixel sPX6, and the fourth pixel PX4 includes a seventh subpixel sPX7 and an eighth subpixel sPX8.

A fifth liquid crystal capacitor Clc5 connected to the third thin film transistor Q3 is formed in the fifth subpixel sPX5, and the sixth liquid crystal capacitor Clc6 connected to the third thin film transistor Q3 is formed in the sixth subpixel sPX6.

The fifth liquid crystal capacitor Clc5 is connected to the second common electrode ComB and the sixth liquid crystal capacitor Clc6 is connected to the first common electrode ComA. As described above, the first common electrode ComA and the second common electrode ComB are applied with the different voltages from each other.

A seventh liquid crystal capacitor Clc7 connected to the fourth thin film transistor Q4 is formed in the seventh subpixel sPX7, and an eighth liquid crystal capacitor Clc8 connected to the fourth thin film transistor Q4 is formed in the eighth subpixel sPX8.

The seventh liquid crystal capacitor Clc7 is connected to the first common electrode ComA, and the eighth liquid crystal capacitor Clc8 is connected to the second common electrode ComB.

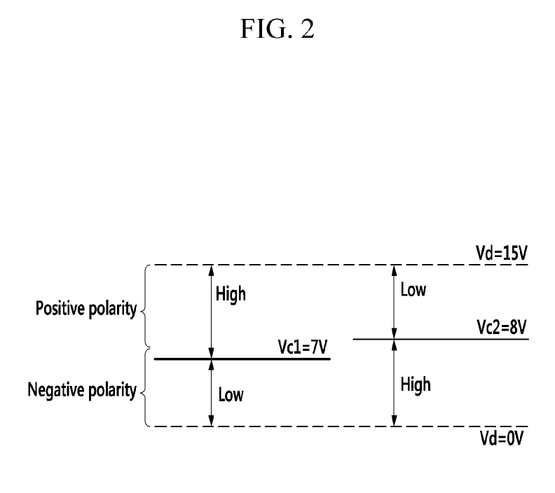

Next, an operation of the liquid crystal display according to an exemplary embodiment of the present inventive concept will be described in detail with reference to FIG. 2 to FIG. 4.

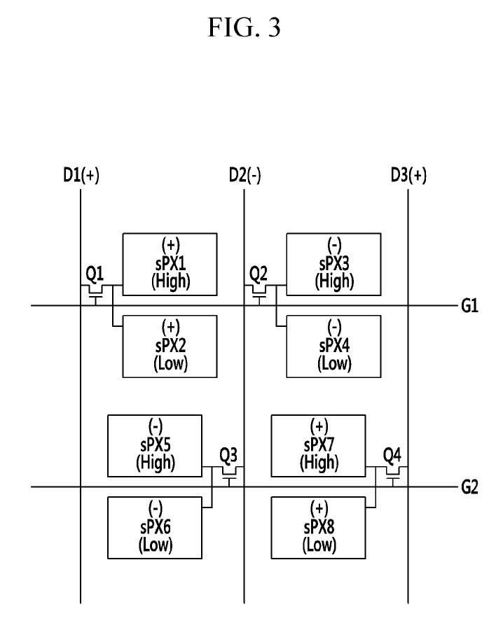

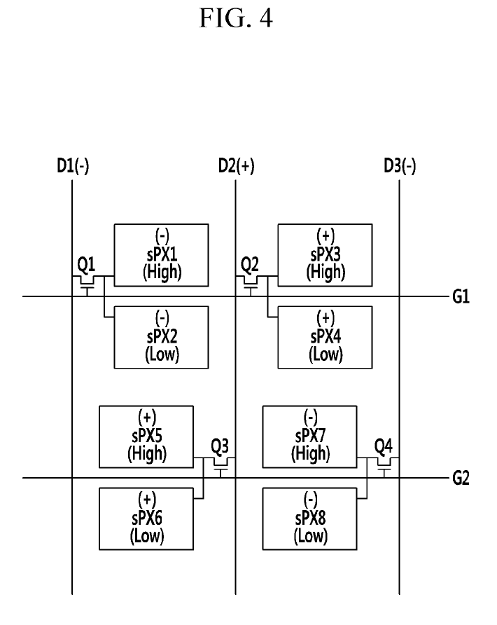

FIG. 2 is a view showing a data voltage Vd transmitted through each data line and a common voltage applied to a common electrode, and FIG. 3 and FIG. 4 are views showing a polarity of a data voltages Vd applied to each pixel of a liquid crystal display according to an exemplary embodiment of the present inventive concept.

First, as shown in FIG. 2, the data voltage Vd may include a voltage of 0V to 15V. The data voltage Vd may include a data voltage Vd having a positive polarity and a data voltage Vd having a negative polarity. The data voltage Vd having positive polarity means a higher voltage than the common voltage, and the data voltage Vd having negative polarity means a lower voltage than the common voltage.

The common voltage may include a first voltage Vc1 and a second voltage Vc2, and the first common electrode ComA and the second common electrode ComB may be alternately applied with the two voltages. However, the first common electrode ComA and the second common electrode ComB are applied with different voltages from each other. The second voltage Vc2 may be higher than the first voltage Vc1, e.g., the first voltage Vc1 may be 7V and the second voltage Vc2 may be 8V.

The values of the data voltage Vd and the common voltage are merely examples and may be variously modified.

As shown in FIG. 3, if the first gate line G1 is applied with the gate-on voltage, the first thin film transistor Q1 and the second thin film transistor Q2 connected thereto are turned on. Accordingly, the first liquid crystal capacitor Clc1 and the second liquid crystal capacitor Clc2 are charged by the data voltage Vd transmitted through the first data line D1, and the third liquid crystal capacitor Clc3 and the fourth liquid crystal capacitor Clc4 are charged by the data voltage Vd transmitted through the second data line D2.

The data voltage Vd having positive polarity may be transmitted through the first data line D1, and the data voltage Vd having negative polarity may be transmitted through the second data line D2. In this case, the first voltage Vc1 may be applied to the first common electrode ComA, and the second voltage Vc2 may be applied to the second common electrode ComB.

The first subpixel sPX1 and the second subpixel sPX2 are applied with the same data voltage Vd. The first liquid crystal capacitor Clc1 is connected to the first common electrode ComA and the second liquid crystal capacitor Clc2 is connected to the second common electrode ComB, such that the charged amount of the first liquid crystal capacitor Clc1 is different from the charged amount of the second liquid crystal capacitor Clc2.

For example, it is assumed that the first data line D1 is applied with the data voltage Vd having a positive polarity of 15V, the first common electrode ComA is applied with the first voltage Vc1 of 7V, and the second common electrode ComB is applied with the second voltage Vc2 of 8V. In this case, a difference between the data voltage Vd and the common voltage is larger in the first subpixel sPX1 rather than the second subpixel sPX2. Accordingly, a higher voltage is applied to the first subpixel sPX1 than the second subpixel sPX2, thereby the first subpixel sPX1 may have a higher transmittance than the second subpixel sPX2. The difference (in the case of a normally black mode) is generated in the transmittance of the first subpixel sPX1 and the second subpixel sPX2 forming the first pixel PX1, such that lateral visibility may be improved.

The third subpixel sPX3 and the fourth subpixel sPX4 are applied with the same data voltage Vd. The third liquid crystal capacitor Clc3 is connected to the second common electrode ComB and the fourth liquid crystal capacitor Clc4 is connected to the first common electrode ComA, such that the charged amount of the third liquid crystal capacitor Clc3 is different from the charged amount of the fourth liquid crystal capacitor Clc4.

For example, the second data line D2 may be applied with the data voltage Vd having a negative polarity of 0V. In this case, the difference between the data voltage Vd and the common voltage is larger in the third subpixel sPX3 rather than the fourth subpixel sPX4. Accordingly, a higher voltage is applied to the third subpixel sPX3 than the fourth subpixel sPX4, thereby the third subpixel sPX3 may have a higher transmittance than the fourth subpixel sPX4.

Next, if the second gate line G2 is applied with the gate-on voltage, the third thin film transistor Q3 and the fourth thin film transistor Q4 connected thereto are turned on. Accordingly, the fifth liquid crystal capacitor Clc5 and the sixth liquid crystal capacitor Clc6 are charged by the data voltage Vd transmitted through the second data line D2, and the seventh liquid crystal capacitor Clc7 and the eighth liquid crystal capacitor Clc8 are charged by the data voltage Vd transmitted through the third data line D3.

In this case, the data voltage Vd having negative polarity may be transmitted to the second data line D2, and the data voltage Vd having positive polarity may be transmitted through the third data line D3. In this case, the first voltage Vc1 may be applied to the first common electrode ComA, and the second voltage Vc2 may be applied to the second common electrode ComB.

The fifth subpixel sPX5 and the sixth subpixel sPX6 are applied with the same data voltage Vd. The fifth liquid crystal capacitor Clc5 is connected to the second common electrode ComB and the sixth liquid crystal capacitor Clc6 is connected to the first common electrode ComA, such that the charged amount of the fifth liquid crystal capacitor Clc5 is different from the charged amount of the sixth liquid crystal capacitor Clc6.

For example, the second data line D2 may be applied with the data voltage Vd having a negative polarity of 0V. In this case, the fifth subpixel sPX5 has a larger voltage difference between the data voltage Vd and the common voltage than the sixth subpixel sPX6. Accordingly, a higher voltage is applied to the fifth subpixel sPX5 than the sixth subpixel sPX6, thereby the fifth subpixel sPX5 may have a higher transmittance than the sixth subpixel sPX6.

The seventh subpixel sPX7 and the eighth subpixel sPX8 are applied with the same data voltage Vd. The seventh liquid crystal capacitor Clc7 is connected to the first common electrode ComA and the eighth liquid crystal capacitor Clc8 is connected to the second common electrode ComB, such that the charged amount of the seventh liquid crystal capacitor Clc7 is different from the charged amount of the eighth liquid crystal capacitor Clc8.

For example, the third data line D3 may be applied with the data voltage Vd having a positive polarity of 15V. In this case, the seventh subpixel sPX7 has a larger voltage difference between the data voltage Vd and the common voltage than the eighth subpixel sPX8. Accordingly, a higher voltage is applied to the seventh subpixel sPX7 than the eighth subpixel sPX8, thereby the seventh subpixel sPX7 may have a higher transmittance than the eighth subpixel sPX8.

In summary, the same data voltage is applied to two subpixels in the same pixel and each liquid crystal capacitor disposed in two subpixels is connected to the common electrode having different common voltages such that different voltage differences between the two subpixels are generated, thereby differentiating the transmittance. In the present inventive concept, even if one data voltage is applied to one pixel having two subpixels through one thin film transistor, the two subpixels may have different transmittance.

Also, by applying data voltages of different polarities to the adjacent data lines, the adjacent pixels in the row direction exhibit different polarities. Also, by connecting the adjacent pixels in the column direction to the different data lines, the adjacent pixels in the column direction exhibit different polarities.

In FIG. 3, the first data line D1 and the third data line D3 are applied with the data voltage Vd having positive polarity, and the second data line D2 is applied with the data voltage Vd having negative polarity. In the following frame, the polarity of the data voltage applied to each data line may be converted. Next, a change of the polarity of the data voltage in the following frame and a driving according thereto will be described with reference FIG. 4.

If the first gate line G1 is applied with the gate-on voltage, the first thin film transistor Q1 and the second thin film transistor Q2 connected thereto are turned on. Accordingly, the first liquid crystal capacitor Clc1 and the second liquid crystal capacitor Clc2 are charged by the data voltage Vd transmitted through the first data line D1, and the third liquid crystal capacitor Clc3 and the fourth liquid crystal capacitor Clc4 are charged by the data voltage Vd transmitted through the second data line D2.

The data voltage Vd having negative polarity may be transmitted through the first data line D1 and the data voltage Vd having positive polarity may be transmitted through the second data line D2. In this case, the first common electrode ComA is applied with the second voltage Vc2, and the second common electrode ComB is applied with the first voltage Vc1, which is lower than the second voltage Vc2.

The first subpixel sPX1 and the second subpixel sPX2 are applied with the same data voltage Vd. The first liquid crystal capacitor Clc1 and the second liquid crystal capacitor Clc2 are connected to the common electrode applied with different common voltages, thereby differentiating the charged amount. In this case, the first subpixel sPX1 has a higher voltage difference than the second subpixel sPX2, such that the higher transmittance is exhibited. As described above, a higher voltage is applied to the first subpixel sPX1 than the second subpixel sPX2 in the previous frame. That is, the first subpixel sPX1 always exhibits higher transmittance than the second subpixel sPX2.

The third subpixel sPX3 and the fourth subpixel sPX4 are applied with the same data voltage Vd. The third liquid crystal capacitor Clc3 and the fourth liquid crystal capacitor Clc4 are connected to the common electrode applied with different common voltages, thereby differentiating the charged amount. In this case, the third subpixel sPX3 has a higher voltage difference than the fourth subpixel sPX4, thereby exhibiting higher transmittance. As described above, a higher voltage is applied to the third subpixel sPX3 than the fourth subpixel sPX4 in the previous frame. That is, the third subpixel sPX3 always exhibits higher transmittance than the fourth subpixel sPX4.

Next, if the second gate line G2 is applied with the gate-on voltage, the third thin film transistor Q3 and the fourth thin film transistor Q4 connected thereto are turned on. Accordingly, the fifth liquid crystal capacitor Clc5 and the sixth liquid crystal capacitor Clc6 are charged by the data voltage Vd transmitted through the second data line D2, and the seventh liquid crystal capacitor Clc7 and the eighth liquid crystal capacitor Clc8 are charged by the data voltage Vd transmitted through the third data line D3.

The data voltage Vd having positive polarity may be transmitted through the second data line D2, and the data voltage Vd having negative polarity may be transmitted through the third data line D3. In this case, the first common electrode ComA is applied with the first voltage Vc1, and the second common electrode ComB is applied with the second voltage Vc2, which is higher than the first voltage Vc1.

The fifth subpixel sPX5 and the sixth subpixel sPX6 are applied with the same data voltage Vd. The fifth liquid crystal capacitor Clc5 and the sixth liquid crystal capacitor Clc6 are connected to the common electrodes applied with different common voltages, thereby differentiating the charged amount. In this case, the fifth subpixel sPX5 has a higher voltage difference than the sixth subpixel sPX6, thereby exhibiting higher transmittance. As described above, a higher voltage is applied to the fifth subpixel sPX5 than the sixth subpixel sPX6 in the previous frame. That is, the fifth subpixel sPX5 always exhibits higher transmittance than the sixth subpixel sPX6.

The seventh subpixel sPX7 and the eighth subpixel sPX8 are applied with the same data voltage Vd. The seventh liquid crystal capacitor Clc7 and the eighth liquid crystal capacitor Clc8 are connected to the common electrodes applied with different common voltages, thereby differentiating the charged amount. In this case, a higher voltage is applied to the seventh subpixel sPX7 than the eighth subpixel sPX8, thereby the seventh subpixel sPX7 may have higher transmittance. As described above, a higher voltage is applied to the seventh subpixel sPX7 than the eighth subpixel sPX8 in the previous frame. That is, the seventh subpixel sPX7 always exhibits higher transmittance than the eighth subpixel sPX8.

In summary, one of two subpixels in the same pixel exhibits higher transmittance than the other subpixel. Although the polarity of the data voltage applied to the data line is changed, the first subpixel sPX1, the third subpixel sPX3, the fifth subpixel sPX5, and the seventh subpixel sPX7 respectively exhibit higher transmittance than the second subpixel sPX2, the fourth subpixel sPX4, the sixth subpixel sPX6, and the eighth subpixel sPX8. To form the area of the subpixel having the low transmittance characteristic Low to be wider than the area of the subpixel having the high transmittance characteristic High results in the advantage of improved visibility. In the present exemplary embodiment, the areas of the second subpixel sPX2, the fourth subpixel sPX4, the sixth subpixel sPX6, and the eighth subpixel sPX8 are formed to be wider than the first subpixel sPX1, the third subpixel sPX3, the fifth subpixel sPX5, and the seventh subpixel sPX7, thereby improving visibility.

Also, in an exemplary embodiment of the present inventive concept, common electrodes applied with the same common voltage are not formed in adjacent pixels in the row direction. That is, common electrodes applied with different common voltages are formed in the adjacent pixels in the row direction. Accordingly, the subpixels having high transmittance characteristic High are adjacent to each other in the row direction, and the subpixels having the low transmittance characteristic Low are adjacent to each other in the row direction. That is, the subpixels having the high transmittance characteristic High and the subpixels having the low transmittance characteristic Low are not disposed in a lattice shape, thereby preventing staining of the lattice shape.

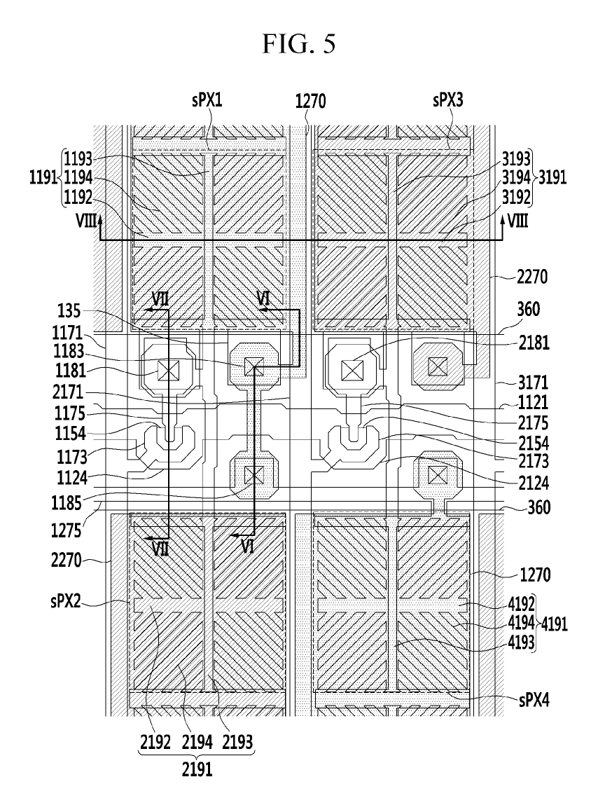

Next, a structure of the first pixel and the second pixel of the liquid crystal display according to an exemplary embodiment of the present inventive concept will be described with reference to FIG. 5 to FIG. 8.

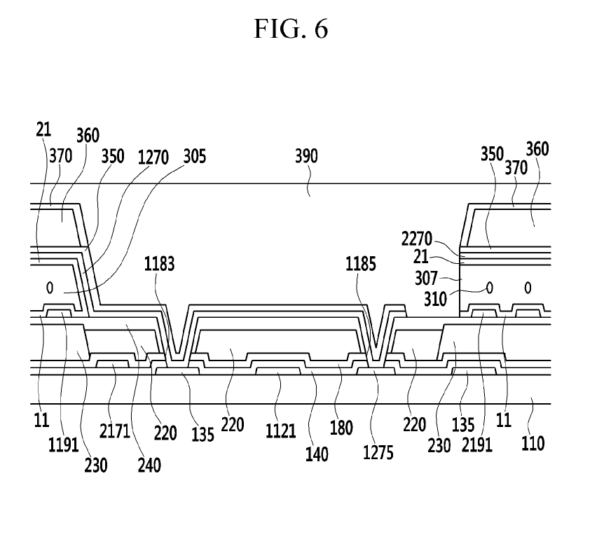

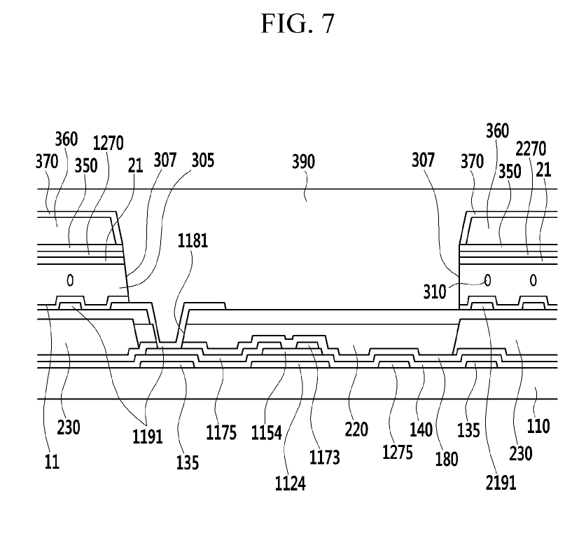

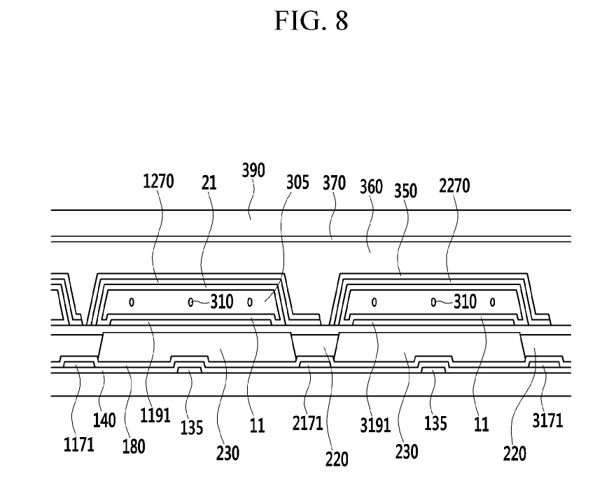

FIG. 5 is a layout view of a portion of a liquid crystal display according to an exemplary embodiment of the present inventive concept, FIG. 6 is a cross-sectional view of a liquid crystal display according to an exemplary embodiment of the present inventive concept of FIG. 5 taken along line VI-VI, FIG. 7 is a cross-sectional view of a liquid crystal display according to an exemplary embodiment of the present inventive concept of FIG. 5 taken along line VII-VII, and FIG. 8 is a cross-sectional view of a liquid crystal display according to an exemplary embodiment of the present inventive concept of FIG. 5 taken along line VIII-VIII.

Referring to FIG. 5 to FIG. 8, a first gate line 1121, and a first gate electrode 1124 and a second gate electrode 2124 protruding from the first gate line 1121 are formed on the substrate 110. The first gate line 1121 substantially extends in a horizontal direction and transmits the gate signal.

A first common electrode line 1275 is formed on the substrate 110. The first common electrode line 1275 may be formed on the same layer as the first gate line 1121 and may extend in a direction parallel to the first gate line 1121. The first common electrode line 1275 transmits the common voltage and the common voltage may include the first voltage and the second voltage. The first common electrode line 1275 is alternately applied one frame at a time with the first voltage and the second voltage.

The storage electrode 135 is further formed on the substrate 110. The storage electrode 135 is formed within the first subpixel sPX1, the second subpixel sPX2, the third subpixel sPX3, and the fourth subpixel sPX4. The storage electrode 135 may be formed on the same layer as the first gate line 1121. The storage electrode 135 may be formed in a horizontal direction and a vertical direction, the shape thereof may be variously modified, and it may be omitted if necessary.

A gate insulating layer 140 is formed on the first gate line 1121, the first gate electrode 1124, the second gate electrode 2124, the first common electrode line 1275, and the storage electrode 135. The gate insulating layer 140 may be made of an inorganic insulating material such as silicon nitride (SiNx) or silicon oxide (SiOx). Also, the gate insulating layer 140 may be made of a single layer or multiple layers.

A first semiconductor 1154 and a second semiconductor 2154 are formed on the gate insulating layer 140. The first semiconductor 1154 may be disposed on the first gate electrode 1124, and the second semiconductor 2154 may be disposed on the second gate electrode 2124. The first semiconductor 1154 and the second semiconductor 2154 may be made of an amorphous silicon, a polycrystalline silicon, or a metal oxide.

Ohmic contacts (not shown) may be further formed on the first semiconductor 1154 and the second semiconductor 2154. The ohmic contacts may be made of a material such as n+ hydrogenated amorphous silicon in which an n-type impurity such as phosphorus is doped with a high concentration, or of silicide.

A first data line 1171, a second data line 2171, a third data line 3171, a first source electrode 1173, a first drain electrode 1175, a second source electrode 2173, and a second drain electrode 2175 are formed on the first semiconductor 1154, the second semiconductor 2154, and the gate insulating layer 140.

The first data line 1171, the second data line 2171, and the third data line 3171 substantially extend in a vertical direction and intersect the first gate line 1121. The first data line 1171, the second data line 2171, and the third data line 3171 transmit the data signal. The second data line 2171 transmits the data voltage having a different polarity from the first data line 1171, and the third data line 3171 transmits the data voltage having the same polarity to the first data line 1171.

The first source electrode 1173 is formed to protrude from the first data line 1171 on the first gate electrode 1124, and the second source electrode 2173 is formed to protrude from the second data line 2171 on the second gate electrode 2124. The first drain electrode 1175 and the second drain electrode 2175 have wide end portions at one side thereof, and bar-shaped end portions at the other side thereof. The wide end portions of the first drain electrode 1175 and the second drain electrode 2175 overlap the storage electrode 135. The bar-shaped end portions of the first drain electrode 1175 and the second drain electrode 2175 are partially enclosed by the first source electrode 1173 and the second source electrode 2173.

The first gate electrode 1124, the first source electrode 1173, and the first drain electrode 1175 form the first thin film transistor Q1 along with the first semiconductor 1154, and the channel of the first thin film transistor Q1 is formed in the first semiconductor 1154 between the first source electrode 1173 and the first drain electrode 1175. The second gate electrode 2124, the second source electrode 2173, and the second drain electrode 2175 form the second thin film transistor Q2 along with the second semiconductor 2154, and the channel of the second thin film transistor Q2 is formed in the second semiconductor 2154 between the second source electrode 2173 and the second drain electrode 2175.

A passivation layer 180 is formed on the first data line 1171, the second data line 2171, the third data line 3171, the first source electrode 1173, the second source electrode 2173, the first drain electrode 1175, and the second drain electrode 2175. The passivation layer 180 may be made of an organic insulating material or the inorganic insulating material and may be formed of a single layer or multiple layers.

A color filter 230 is formed on the passivation layer 180 in the first pixel PX1 and the second pixel PX2.

Each color filter 230 may display one of the primary colors, such as one of the three primary colors red, green, or blue. The color filter 230 is not limited to the three primary colors of red, green, and blue, and may also display cyan, magenta, yellow, and white-based colors.

A light blocking member 220 is formed at a region between the adjacent color filters 230. The light blocking member 220 is formed on the boundary of the first pixel PX1 and the second pixel PX2 and the first thin film transistor Q1 and the second thin film transistor Q2, thereby preventing light leakage. The color filter 230 and the light blocking member 220 may overlap each other in some regions.

A first insulating layer 240 may be further formed on the color filter 230 and the light blocking member 220. The first insulating layer 240 may be formed of the organic insulating material or the inorganic insulating material and may be formed of a single layer or multiple layers. The first insulating layer 240 may include the organic insulating material and the inorganic insulating material laminated each other.

The passivation layer 180 and the first insulating layer 240 have a contact hole 1181 exposing the wide end portion of the first drain electrode 1175 and a contact hole 2181 exposing the wide end portion of the second drain electrode 2175.

First pixel electrodes 1191 and 2191 and second pixel electrode 3191 and 4191 are formed on the first insulating layer 240. The first pixel electrodes 1191 and 2191 are disposed in the first pixel PX1, and the second pixel electrodes 3191 and 4191 are disposed in the second pixel PX2. The first pixel electrodes 1191 and 2191 and the second pixel electrodes 3191 and 4191 may be formed of a transparent metal oxide such as indium-tin oxide (ITO) or indium-zinc oxide (IZO).

The first pixel electrodes include a first subpixel electrode 1191 and a second subpixel electrode 2191. The first subpixel electrode 1191 is disposed in the first subpixel sPX1, and the second subpixel electrode 2191 is disposed in the second subpixel sPX2. The first subpixel electrode 1191 and the second subpixel electrode 2191 are connected to each other. A ratio of the first subpixel electrode 1191 to the second subpixel electrode 2191 may be about 1:1 to about 1:2. Preferably, the ratio of the first subpixel electrode 1191 to the second subpixel electrode 2191 may be about 1:1.5 to about 1:2.

The first subpixel electrode 1191 and the second subpixel electrode 2191 are connected to the first drain electrode 1175 through the contact hole 1181. Accordingly, when the first thin film transistor Q1 is turned on, the first subpixel electrode 1191 and the second subpixel electrode 2191 are applied with the same data voltage from the first drain electrode 1175.

The second pixel electrodes include the third subpixel electrode 3191 and the fourth subpixel electrode 4191. The third subpixel electrode 3191 is disposed in the third subpixel sPX3, and the fourth subpixel electrode 4191 is disposed in the fourth subpixel sPX4. The third subpixel electrode 3191 and the fourth subpixel electrode 4191 are connected to each other. The ratio of the third subpixel electrode 3191 to the fourth subpixel electrode 4191 may be about 1:1 to about 1:2. Preferably, the ratio of the third subpixel electrode 3191 to the fourth subpixel electrode 4191 may be about 1:1.5 to about 1:2.

The third subpixel electrode 3191 and the fourth subpixel electrode 4191 are connected to the second drain electrode 2175 through the contact hole 2181. Accordingly, when second thin film transistor Q2 is turned on, the third subpixel electrode 3191 and the fourth subpixel electrode 4191 are applied with the same data voltage from the second drain electrode 2175.

The overall shape of each of the first subpixel electrode 1191, the second subpixel electrode 2191, the third subpixel electrode 3191, and fourth subpixel electrode 4191 is a quadrangle. The first subpixel electrode 1191, the second subpixel electrode 2191, the third subpixel electrode 3191, and the fourth subpixel electrode 4191 respectively include a crossed-shape stem including transverse stems 1192, 2192, 3192, and 4192 and longitudinal stems 1193, 2193, 3193, and 4193 crossing the transverse stems 1192, 2192, 3192, and 4192. Also, the first subpixel electrode 1191, the second subpixel electrode 2191, the third subpixel electrode 3191, and the fourth subpixel electrode 4191 respectively include a plurality of minute branches 1194, 2194, 3194, and 4194 extending obliquely from the crossed-shape stem.

The first subpixel electrode 1191, the second subpixel electrode 2191, the third subpixel electrode 3191, and the fourth subpixel electrode 4191 are respectively divided into four subregions by the transverse stems 1192, 2192, 3192, and 4192 and the longitudinal stems 1193, 2193, 3193, and 4193. The minute branches 1194, 2194, 3194, and 4194 obliquely extend from the transverse stems 1192, 2192, 3192, 4192 and the longitudinal stems 1193, 2193, 3193, 4193, and the extending directions thereof may form an angle of about 45 degrees or about 135 degrees with the first gate line 1121 or the transverse stems 1192, 2192, 3192, 4192. Also, the extending directions of the minute branches 1194, 2194, 3194, 4194 of the two adjacent subregions may be perpendicular to each other.

Although not shown, the first subpixel electrode 1191, the second subpixel electrode 2191, the third subpixel electrode 3191, and the fourth subpixel electrode 4191 respectively further include an outer stem connecting the outer portions of the first subpixel sPX1, the second subpixel sPX2, the third subpixel sPX3, and the fourth subpixel sPX4.

The aforementioned arrangement of the pixels, the structure of the thin film transistor, and the shape of the pixel electrode are just examples and the present inventive concept is not limited thereto, thus various modifications are possible.

On the first subpixel electrode 1191, a first common electrode 1270 is formed to be separate from the first subpixel electrode 1191 by a predetermined distance. The first subpixel electrode 1191 overlaps the first common electrode 1270, and a microcavity 305 is formed between the first subpixel electrode 1191 and the first common electrode 1270. That is, the microcavity 305 is enclosed by the first subpixel electrode 1191 and the first common electrode 1270. The first common electrode 1270 is formed to cover the upper surface and the side surface of the microcavity 305. The size of one pixel may vary depending on the size and resolution of the display device, and thus the size of the microcavity 305 changes accordingly.

The first common electrode 1270 may overlap the second data line 2171. Also, the first common electrode 1270 overlaps the storage electrode 135 and overlaps the first common electrode line 1275. The passivation layer 180 and the first insulating layer 240 have contact holes 1183 and 1185 exposing the portions of the storage electrode 135 and the first common electrode line 1275. The first common electrode 1270 is connected to the storage electrode 135 and the first common electrode line 1275 through the contact holes 1183 and 1185. The first common electrode 1270 is applied with the common voltage through the first common electrode line 1275.

On the second subpixel electrode 2191, the second common electrode 2270 is formed to be separate from the second subpixel electrode 2191 by a predetermined distance. The second subpixel electrode 2191 overlaps the second common electrode 2270 and the microcavity 305 is formed between the second subpixel electrode 2191 and the second common electrode 2270. Also, on the third subpixel electrode 3191, a second common electrode 2270 is formed to be separate from the third subpixel electrode 3191 by a predetermined distance. The third subpixel electrode 3191 overlaps the second common electrode 2270, and the microcavity 305 is formed between the third subpixel electrode 3191 and the second common electrode 2270. Also, on the fourth subpixel electrode 4191, the first common electrode 1270 is formed to be separate from the fourth subpixel electrode 4191 by a predetermined distance. The fourth subpixel electrode 4191 overlaps the first common electrode 1270 and the microcavity 305 is formed between the fourth subpixel electrode 4191 and the first common electrode 1270.

The first common electrode 1270 and the second common electrode 2270 may be made of a transparent metal oxide such as indium-tin oxide (ITO) or indium-zinc oxide (IZO).

A first alignment layer 11 is formed on the first pixel electrodes 1191 and 2191 and the second pixel electrodes 3191 and 4191. A second alignment layer 21 is formed under the first common electrode 1270 and the second common electrode 2270 to face the first alignment layer 11.

The first alignment layer 11 and the second alignment layer 21 may be formed by vertical alignment layers, and made of alignment materials such as polyamic acid, polysiloxane, and polyimide. The first and second alignment layers 11 and 21 may be connected to each other at a side wall of the edge of the microcavity 305.

A liquid crystal layer including liquid crystal molecules 310 is formed in the microcavity 305. The liquid crystal molecules 310 may have a negative dielectric anisotropy and may be aligned in the direction vertical to the substrate 110 in the absence of an electric field. That is, the vertical alignment may be realized.

The first subpixel electrode 1191 and the fourth subpixel electrode 4191 applied with the data voltage generate the electric field along with the first common electrode 1270 to determine the direction of the liquid crystal molecules 310 positioned in the microcavity 305. Also, the second subpixel electrode 2191 and the third subpixel electrode 3191 generate the electric field along with the second common electrode 2270 to determine the direction of the liquid crystal molecules 310 positioned in the microcavity 305. As such, luminance of light passing through the liquid crystal layer varies according to the determined directions of the liquid crystal molecules 310.

A second insulating layer 350 may be further formed on the first common electrode 1270 and the second common electrode 2270. The second insulating layer 350 may be made of an inorganic insulating material such as silicon nitride (SiNx) or silicon oxide (SiOx), and may be omitted if necessary.

A roof layer 360 is formed on the second insulating layer 350. The roof layer 360 may be made of an organic material. The roof layer 360 is formed in a substantially horizontal direction and covers a plurality of microcavities 305 disposed in the row direction. The roof layer 360 is formed to cover the upper surface and the side surface of the plurality of microcavities 305. The roof layer 360 may be hardened by a curing process to maintain a shape of the microcavity 305.

The first common electrode 1270, the second common electrode 2270, and the roof layer 360 are formed to cover the side surface of part of the edge of the microcavity 305 and are formed to expose the side surface of the other part of the edge. In this case, the portion of the microcavity 305 that is not covered by the first common electrode 1270, the second common electrode 2270, and the roof layer 360 is referred to as an injection hole 307. The injection hole 307 exposes the side surface of the first edge of the microcavity 305 and the side surface of the second edge, and the first edge and the second edge face each other. For example, in the plane view, the first edge may be the upper edge of the microcavity 305, and the second edge may be the lower edge of the microcavity 305.

Since the microcavity 305 is exposed by the injection hole 307, an aligning agent or a liquid crystal material may be injected in the microcavity 305 through the injection hole 307.

A third insulating layer 370 may be further formed on the roof layer 360. The third insulating layer 370 may be formed of an inorganic insulating material such as silicon nitride (SiNx) or silicon oxide (SiOx). The third insulating layer 370 may be formed to cover the upper surface and the side surface of the roof layer 360. The role of the third insulating layer 370 is to protect the roof layer 360 that is formed of organic materials, and it may be omitted in some cases.

An encapsulation layer 390 is formed on the third insulating layer 370. The encapsulation layer 390 is formed to cover the injection hole 307 exposing part of the microcavity 305. That is, the encapsulation layer 390 may seal the microcavity 305 so that the liquid crystal molecules 310 formed in the microcavity 305 are not discharged outside. Since the encapsulation layer 390 contacts the liquid crystal molecules 310, the encapsulation layer 390 may be made of a material which does not react with the liquid crystal molecules 310. For example, the encapsulation layer 390 may be made of parylene and the like.

The encapsulation layer 390 may be formed in multiple layers, such as a double layer or a triple layer. The double layer is configured of two layers made of different materials. The triple layer is configured of three layers, and the materials of adjacent layers are different from each other. For example, the encapsulation layer 390 may include a layer made of an organic insulating material and a layer made of an inorganic insulating material.

Although not illustrated, polarizers may be further formed on upper surface and lower surface of the liquid crystal display. The polarizers may be configured by a first polarizer and a second polarizer. The first polarizer may be attached to the lower surface of the substrate 110, and the second polarizer may be attached to the encapsulation layer 390.

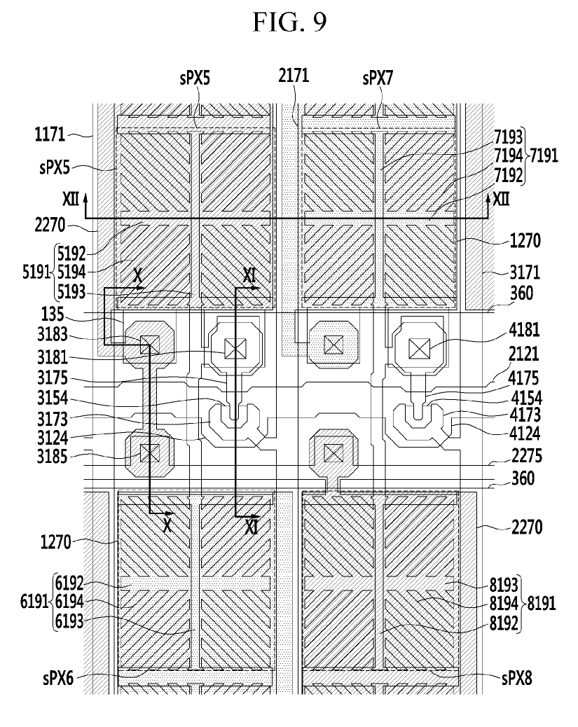

Next, a structure of the third pixel and the fourth pixel of the liquid crystal display according to an exemplary embodiment of the present inventive concept will be described with reference to FIG. 9 to FIG. 12. As shown in FIG. 1, the third pixel and the fourth pixel are positioned under the first pixel and the second pixel in the plane view.

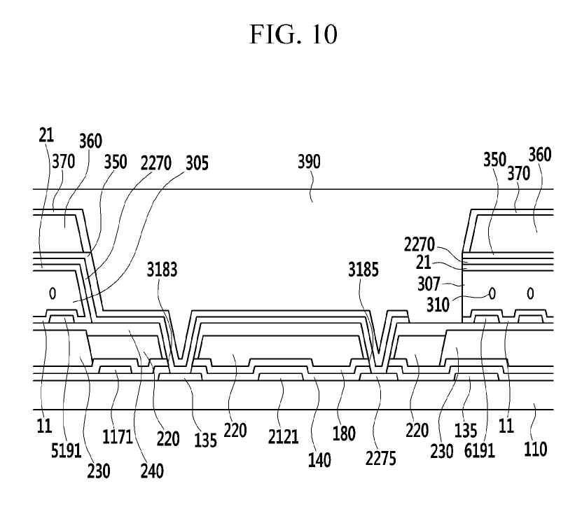

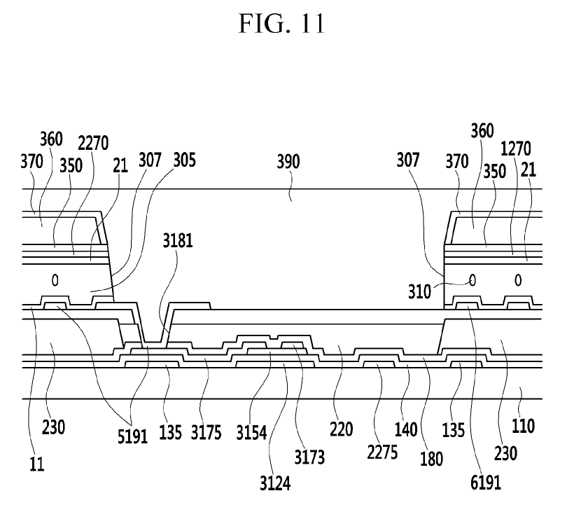

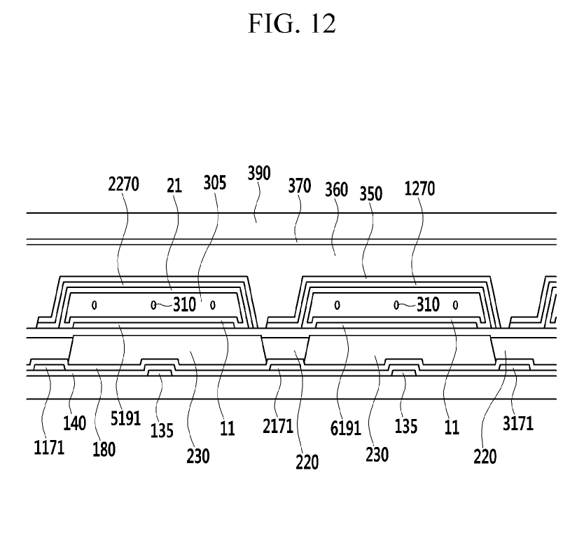

FIG. 9 is a layout view of a portion of a liquid crystal display according to an exemplary embodiment of the present inventive concept, FIG. 10 is a cross-sectional view of a liquid crystal display according to an exemplary embodiment of the present inventive concept of FIG. 9 taken along line X-X, FIG. 11 is a cross-sectional view of a liquid crystal display according to an exemplary embodiment of the present inventive concept of FIG. 9 taken along line XI-XI, and FIG. 12 is a cross-sectional view of a liquid crystal display according to an exemplary embodiment of the present inventive concept of FIG. 9 taken along line XII-XII.

Referring to FIG. 9 to FIG. 12, a second gate line 2121, and a third gate electrode 3124 and a fourth gate electrode 4124 protruding from the second gate line 2121, are formed on the substrate 110. The second gate line 2121, the third gate electrode 3124, and the fourth gate electrode 4124 may be formed on the same layer as the above-described first gate line 1121.

The second gate line 2121 substantially extends in a horizontal direction and transmits the gate signal. The second gate line 2121 extends in a same direction to the first gate line 1121. The gate signal may include the gate-on voltage and the gate-off voltage, and the first gate line 1121 and the second gate line 2121 are sequentially applied with the gate-on voltage.

A second common electrode line 2275 may be further formed on the substrate 110. The second common electrode line 2275 may be formed on the same layer as the second gate line 2121 and extend in a direction parallel to the second gate line 2121. The second common electrode line 2275 transmits the common voltage, and the common voltage may include the first voltage and the second voltage. The second common electrode line 2275 is alternately applied one frame at a time with the first voltage and the second voltage. When the first common electrode line 1275 is applied with the first voltage, the second common electrode line 2275 is applied with the second voltage, and when the first common electrode line 1275 is applied with the second voltage, the second common electrode line 2275 is applied with the first voltage.

The above-described storage electrode 135 may be further formed in the fifth subpixel sPX5, the sixth subpixel sPX6, the seventh subpixel sPX7, and the eighth subpixel sPX8.

The gate insulating layer 140 is formed on the second gate line 2121, the third gate electrode 3124, the fourth gate electrode 4124, and the second common electrode line 2175.

A third semiconductor 3154 and a fourth semiconductor 4154 are formed on the gate insulating layer 140. The third semiconductor 3154 may be disposed on the third gate electrode 3124, and the fourth semiconductor 4154 may be disposed on the fourth gate electrode 4124. The ohmic contacts may be further formed on the third semiconductor 3154 and the fourth semiconductor 4154.

A third source electrode 3173, a third drain electrode 3175, a fourth source electrode 4173, and a fourth drain electrode 4175 are formed on the third semiconductor 3154, the fourth semiconductor 4154, and the gate insulating layer 140.

The third source electrode 3173 is formed to protrude on the third gate electrode 3124 from the second data line 2171, and the fourth source electrode 4173 is formed to protrude on the fourth gate electrode 4124 from the third data line 3171. The third drain electrode 3175 and the fourth drain electrode 4175 include wide end portions and bar-shaped end portions. The wide end portions of the third drain electrode 3175 and the fourth drain electrode 4175 overlap the storage electrode 135. The bar-shaped end portions of the third drain electrode 3175 and the fourth drain electrode 4175 are respectively partially enclosed by the third source electrode 3173 and the fourth source electrode 4173.

The third gate electrode 3124, the third source electrode 3173, and the third drain electrode 3175 form the third thin film transistor Q3 along with the third semiconductor 3154, and the channel of the third thin film transistor Q3 is formed in the third semiconductor 3154 between the third source electrode 3173 and the third drain electrode 3175. The fourth gate electrode 4124, the fourth source electrode 4173, and the fourth drain electrode 4175 form the fourth thin film transistor Q4 along the fourth semiconductor 4154, and the channel of the fourth thin film transistor Q4 is formed in the fourth semiconductor 4154 between the fourth source electrode 4173 and the fourth drain electrode 4175.

The passivation layer 180 is formed on the third source electrode 3173, the fourth source electrode 4173, the third drain electrode 3175, and the fourth drain electrode 4175.

The color filter 230 is formed in the third pixel PX3 and in the fourth pixel PX4 on the passivation layer 180. The light blocking member 220 is formed in the region between the color filters 230. The first insulating layer 240 is formed on the color filter 230 and the light blocking member 220.

The passivation layer 180 and the first insulating layer 240 have the contact hole 3181 exposing the wide end portion of the third drain electrode 3175 and the contact hole 4181 exposing the wide end portion of the fourth drain electrode 4175.

The third pixel electrode 5191 and 6191 and the fourth pixel electrodes 7191 and 8191 are formed on the first insulating layer 240. The third pixel electrodes 5191 and 6191 are disposed in the third pixel PX3, and the fourth pixel electrodes 7191 and 8191 are disposed in the fourth pixel PX4. The third pixel electrodes 5191 and 6191 and the fourth pixel electrodes 7191 and 8191 may be made of a transparent metal oxide such as indium-tin oxide (ITO) or indium-zinc oxide (IZO).

The third pixel electrodes include the fifth subpixel electrode 5191 and the sixth subpixel electrode 6191. The fifth subpixel electrode 5191 is disposed in the fifth subpixel sPX5, and the sixth subpixel electrode 6191 is disposed in the sixth subpixel sPX6. The fifth subpixel electrode 5191 and the sixth subpixel electrode 6191 are connected to each other. The ratio of the fifth subpixel electrode 5191 to the sixth subpixel electrode 6191 may be about 1:1 to about 1:2. Preferably, the ratio of the fifth subpixel electrode 5191 to the sixth subpixel electrode 6191 may be about 1:1.5 to about 1:2.

The fifth subpixel electrode 5191 and the sixth subpixel electrode 6191 are connected to the third drain electrode 3175 through the contact hole 3181. Accordingly, when the third thin film transistor Q3 is turned on, the fifth subpixel electrode 5191 and the sixth subpixel electrode 6191 are applied with the same data voltage from the third drain electrode 3175.

The fourth pixel electrodes include the seventh subpixel electrode 7191 and the eighth subpixel electrode 8191. The seventh subpixel electrode 7191 is disposed in the seventh subpixel sPX7, and the eighth subpixel electrode 8191 is disposed in the eighth subpixel sPX8. The seventh subpixel electrode 7191 and the eighth subpixel electrode 8191 are connected to each other. The ratio of the seventh subpixel electrode 7191 to the eighth subpixel electrode 8191 may be about 1:1 to about 1:2. Preferably, the ratio of the seventh subpixel electrode 7191 to the eighth subpixel electrode 8191 may be about 1:1.5 to about 1:2.

The seventh subpixel electrode 7191 and the eighth subpixel electrode 8191 are connected to the fourth drain electrode 4175 through the contact hole 4181. Accordingly, when the fourth thin film transistor Q4 is turned on, the seventh subpixel electrode 7191 and the eighth subpixel electrode 8191 are applied with the same data voltage from the fourth drain electrode 4175.

The shape of each of the fifth subpixel electrode 5191, the sixth subpixel electrode 6191, the seventh subpixel electrode 7191, and the eighth subpixel electrode 8191 is a quadrangle. The fifth subpixel electrode 5191, the sixth subpixel electrode 6191, the seventh subpixel electrode 7191, and the eighth subpixel electrode 8191 respectively include a crossed-shape stem including transverse stems 5192, 6192, 7192, and 8192 and longitudinal stems 5193, 6193, 7193, and 8193 crossing the transverse stems 5192, 6192, 7192, and 8192. Also, the fifth subpixel electrode 5191, the sixth subpixel electrode 6191, the seventh subpixel electrode 7191, and the eighth subpixel electrode 8191 respectively include a plurality of minute branches 5194, 6194, 7194, and 8194 extending obliquely from the crossed-shape stem.

The fifth subpixel electrode 5191, the sixth subpixel electrode 6191, the seventh subpixel electrode 7191, and the eighth subpixel electrode 8191 are respectively divided into four subregions by the transverse stems 5192, 6192, 7192, and 8192 and the longitudinal stems 5193, 6193, 7193, and 8193. The minute branches 5194, 6194, 7194, and 8194 obliquely extend from the transverse stems 5192, 6192, 7192, and 8192 and the longitudinal stems 5193, 6193, 7193, and 8193, and the extending directions thereof may form an angle of about 45 degrees or about 135 degrees with the first gate line 2121 or the transverse stems 5192, 6192, 7192, and 8192. Also, the extending directions of the minute branches 5194, 6194, 7194, and 8194 of the two adjacent subregions may be perpendicular to each other.

Although not shown, the fifth subpixel electrode 5191, the sixth subpixel electrode 6191, the seventh subpixel electrode 7191, and the eighth subpixel electrode 8191 respectively further include an outer stem connecting the outer portions of the fifth subpixel sPX5, the sixth subpixel sPX6, the seventh subpixel sPX7, and the eighth subpixel sPX8.

The aforementioned arrangement of the pixels, the structure of the thin film transistor, and the shape of the pixel electrode are just examples and the present inventive concept is not limited thereto, thus various modifications are possible.

On the fifth subpixel electrode 5191, a second common electrode 2270 is formed to be separate from the fifth subpixel electrode 5191 by a predetermined distance. The fifth subpixel electrode 5191 overlaps the second common electrode 2270, and the microcavity 305 is formed between the fifth subpixel electrode 5191 and the second common electrode 2270.

The second common electrode 2270 may overlap the first data line 1171. Also, the second common electrode 2270 overlaps the storage electrode 135 and overlaps the second common electrode line 2275. The passivation layer 180 and the first insulating layer 240 have the contact holes 3183 and 3185 exposing a portion of the storage electrode 135 and the second common electrode line 1275. The second common electrode 2270 is connected to the storage electrode 135 and the second common electrode line 2175 through the contact holes 3183 and 3185. The second common electrode 2270 receives the common voltage through the second common electrode line 2275.

On the sixth subpixel electrode 6191, the first common electrode 1270 is formed to be separate from the sixth subpixel electrode 6191 by a predetermined distance. The sixth subpixel electrode 6191 overlaps the first common electrode 1270, and the microcavity 305 is formed between the sixth subpixel electrode 6191 and the first common electrode 1270. On the seventh subpixel electrode 7191, the first common electrode 1270 is formed to be separate from the seventh subpixel electrode 7191 by a predetermined distance. The seventh subpixel electrode 7191 overlaps the first common electrode 1270, and the microcavity 305 is formed between the seventh subpixel electrode 7191 and the first common electrode 1270. Also, on the eighth subpixel electrode 8191, the second common electrode 2270 is formed to be separate from the eighth subpixel electrode 8191 by a predetermine distance. The eighth subpixel electrode 8191 overlaps the second common electrode 2270, and the microcavity 305 is formed between the eighth subpixel electrode 8191 and the second common electrode 2270.

The microcavity 305 disposed between the fifth subpixel electrode 5191 and the second common electrode 2270 is connected to the microcavity 305 disposed between the fifth subpixel electrode 5191 and the second common electrode 2270. Also, the second common electrode 2270 overlapping the fifth subpixel electrode 5191 is connected to the second common electrode 2270 overlapping the third subpixel electrode 3191.

The microcavity 305 disposed between the seventh subpixel electrode 7191 and the first common electrode 1270 is connected to the microcavity 305 disposed between the fourth subpixel electrode 4191 and the first common electrode 1270. Also, the first common electrode 1270 overlapping the seventh subpixel electrode 7191 is connected to the first common electrode 1270 overlapping the connected fourth subpixel electrode 4191.

The first alignment layer 11 is formed on the third pixel electrodes 5191 and 6191 and the fourth pixel electrodes 7191 and 8191. The second alignment layer 21 is formed under the first common electrode 1270 and the second common electrode 2270 to face the first alignment layer 11.

The liquid crystal layer including the liquid crystal molecules 310 is formed in the microcavity 305. The second insulating layer 350 may be further formed on the first common electrode 1270 and the second common electrode 2270, and the roof layer 360 is formed on the second insulating layer 350. The third insulating layer 370 may be further formed on the roof layer 360, and the encapsulation layer 390 may be formed on the third insulating layer 370.

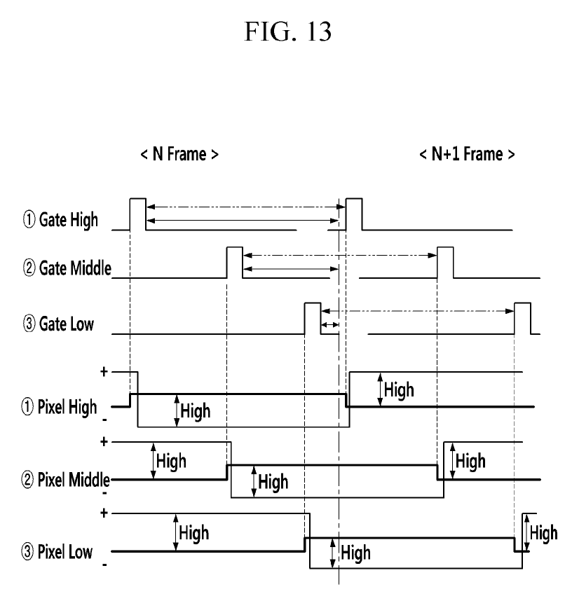

Next, a timing diagram of the signal applied to the liquid crystal display according to an exemplary embodiment of the present inventive concept will be described with reference to FIG. 13.

FIG. 13 is a timing diagram of a signal applied to a liquid crystal display according to an exemplary embodiment of the present inventive concept.

The liquid crystal display according to an exemplary embodiment of the present inventive concept may include a plurality of first common electrodes 1270 and a plurality of first gate lines 1121. The liquid crystal display may be divided into three portions with the direction parallel to the first gate line 1121 as a boundary. For example, the liquid crystal display may be divided into the three regions of high, middle, and low. In FIG. 13, the gate signal applied to the first gate line 1121 respectively positioned in three regions, the data voltage applied to the first subpixel electrode 1191 connected to each first gate line 1121, and the common voltage applied to the first common electrode 1270 overlapping each first subpixel electrode 1191 are shown.

The plurality of first gate lines 1121 may be sequentially applied with the gate-on voltage. The gate-on voltage is first applied to the first gate line 1121 disposed in the high region of the liquid crystal display, the gate-on voltage is next applied to the first gate line 1121 disposed in the middle region, and then the gate-on voltage is applied to the first gate line 1121 in the low region. In FIG. 13, only the signal applied to one first gate line 1121 among the plurality of first gate lines 1121 disposed in each portion is shown, and the signal applied to the rest of the first gate lines 1121 is omitted. The rest of the first gate lines 1121 are also sequentially applied with the gate-on voltage.

When the gate-on voltage is applied to the first gate line 1121 in the high region, the data voltage is applied to the first subpixel electrode 1191 connected to the corresponding first gate line 1121. The data voltage having negative polarity may be applied to the first subpixel electrode 1191 in the N-th frame, and the data voltage having positive polarity may be applied to the first subpixel electrode 1191 in the (N+1)-th frame. Simultaneously, the common voltage applied to the first common electrode 1270 overlapping the corresponding first subpixel electrode 1191 is changed. The common voltage applied to the first common electrode 1270 is changed from the first voltage to the second voltage, which is higher than the first voltage in the N-th frame, and the common voltage applied to the first common electrode 1270 is changed from the second voltage to the first voltage in the (N+1)-th frame.

Next, when the gate-on voltage is applied to the first gate line 1121 in the middle region, the data voltage is applied to the first subpixel electrode 1191 connected to the corresponding first gate line 1121, and simultaneously the common voltage applied to the first common electrode 1270 overlapping the corresponding first subpixel electrode 1191 is changed.

Next, when the gate-on voltage is applied to the first gate line 1121 in the low region, the data voltage is applied to the first subpixel electrode 1191 connected to the corresponding first gate line 1121, and simultaneously the common voltage applied to the first common electrode 1270 overlapping the corresponding first subpixel electrode 1191 is changed.

That is, the timing for when the common voltage applied to the plurality of first common electrodes 1270 is changed from the first voltage to the second voltage, or from the second voltage to the first voltage, is determined depending on the gate signal applied to the first gate line 1121. In this case, the timing for when the common voltage applied to the plurality of first common electrodes 1270 is changed from the first voltage to the second voltage, or from the second voltage to the first voltage, is determined depending on the gate signal applied to the first gate line 1121. The timing for changing the common voltage may synchronize with the timing for when the gate-on voltage is applied to the first gate line 1121.

In this case, the timing for changing the common voltage applied to the plurality of first common electrodes 1270 positioned in the high region may synchronize with the timing for when the gate-on voltage is applied to any one first gate line 1121 in the high region. Also, the timing for changing the common voltage applied to the plurality of first common electrodes 1270 positioned in the middle region may synchronize with the timing for when the gate-on voltage is applied to any one first gate line 1121 positioned in the middle region. Also, the timing for when the common voltage applied to the plurality of first common electrodes 1270 positioned in the low region may synchronize with the timing for when the gate-on voltage is applied to any one first gate line 1121 positioned in the low region.

That is, the timing for changing the common voltage applied to the first common electrode 1270 may be divided into three times. However, the present inventive concept is not limited thereto, and the liquid crystal display may be divided into four or more regions, and the timing for changing the common voltage applied to the first common electrode 1270 may be divided into four or more times. Also, the timing for changing the common voltage applied to the plurality of first common electrodes 1270 may synchronize with the timing for changing the gate-on voltage in the first gate line 1121 adjacent to each first common electrode 1270. In this case, the timing for changing the common voltage applied to the first common electrode 1270 varies according to a number of first gate lines 1121.

Likewise, the timing for changing the common voltage in the second common electrode 2270 may synchronize with the gate-on timing of the second gate line 2121.

If the common voltage applied to all first common electrodes 1270 is changed at the same time when the gate-on voltage is applied to the first gate line 1121, the subpixel having high transmittance in the middle portion of one frame may exhibit low transmittance, and, on the other hand, the subpixel having low transmittance in the middle portion of one frame may have high transmittance. Also, in the pixel positioned in the low region of the liquid crystal display, the subpixel having high transmittance in the early part of one frame exhibits low transmittance, and the subpixel having low transmittance has high transmittance.

In an exemplary embodiment of the present inventive concept, by synchronizing the timing for changing the common voltage applied to the first common electrode 1270 with the timing for changing the gate-on voltage, the transmittance of each subpixel may not be changed during one frame. Accordingly, the response speed of the liquid crystal may be increased and the deviation of visibility depending on the position of the liquid crystal display may be reduced.

While this inventive concept has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims.

What is claimed is:

1. A liquid crystal display comprising:
a substrate;
a first gate line disposed on the substrate;
a first data line and a second data line disposed on the substrate and applied with a data voltage having different polarities;
a first pixel electrode connected to the first gate line and the first data line;
a second pixel electrode connected to the first gate line and the second data line;
a liquid crystal layer disposed on the first pixel electrode and the second pixel electrode;
a first common electrode disposed on the liquid crystal layer and applied with a first voltage; and
a second common electrode disposed on the liquid crystal layer and applied with a second voltage different from the first voltage,
wherein the first pixel electrode includes a first subpixel electrode overlapping the first common electrode and a second subpixel electrode overlapping the second common electrode, and
the second pixel electrode includes a third subpixel electrode overlapping the second common electrode and a fourth subpixel electrode overlapping the first common electrode.

2. The liquid crystal display of claim 1, wherein:
the first subpixel electrode and the second subpixel electrode are connected to each other, and
the third subpixel electrode and the fourth subpixel electrode are connected to each other.

3. The liquid crystal display of claim 1, wherein:
the second voltage is higher than the first voltage,
the data voltage having a positive polarity is applied to the first pixel electrode, and the data voltage having a negative polarity is applied to the second pixel electrode.

4. The liquid crystal display of claim 1, wherein:
the first voltage and the second voltage are alternately applied to the first common electrode and the second common electrode,
the second voltage is applied to the second common electrode when the first common electrode is applied with the first voltage, and
the second common electrode is applied with the first voltage when the first common electrode is applied with the second voltage.

5. The liquid crystal display of claim 4, wherein:
the second voltage is higher than the first voltage,
when the first common electrode is applied with the first voltage and the second common electrode is applied with the second voltage,
the data voltage having a positive polarity is applied to the first pixel electrode and the data voltage having a negative polarity is applied to the second pixel electrode.

6. The liquid crystal display of claim 5, wherein:
when the first common electrode is applied with the second voltage and the second common electrode is applied with the first voltage,
the data voltage having a negative polarity is applied to the first pixel electrode and the data voltage having a positive polarity is applied to the second pixel electrode.

7. The liquid crystal display of claim 4, wherein:
a timing for changing the common voltage applied to the first common electrode is determined depending on a timing for applying a gate signal to the first gate line.

8. The liquid crystal display of claim 7, wherein:
a timing for changing the common voltage applied to the first common electrode is synchronized with a timing for applying a gate-on voltage to the first gate line.

9. The liquid crystal display of claim 4, wherein:
the liquid crystal display includes a plurality of the first common electrodes and a plurality of the first gate lines,
the plurality of first gate lines are sequentially applied with the gate-on voltage, and
the timing for changing the common voltage applied to the plurality of first common electrodes is determined depending on a timing for applying the signal to the first gate line adjacent to each first common electrode.

10. The liquid crystal display of claim 9, wherein:
the timing for changing the common voltage applied to the plurality of first common electrodes is synchronized with a timing for applying a gate-on voltage to each first gate line adjacent to each first common electrode.

11. The liquid crystal display of claim 1, further comprising:
a second gate line disposed on the substrate;
a third data line disposed on the substrate and applied with the data voltage having the same polarity as the first data line;
a third pixel electrode connected to the second gate line and the second data line; and
a fourth pixel electrode connected to the second gate line and the third data line,
wherein the third pixel electrode includes a fifth subpixel electrode overlapping the second common electrode and a sixth subpixel electrode overlapping the first common electrode, and
the fourth pixel electrode includes a seventh subpixel electrode overlapping the first common electrode and an eighth subpixel electrode the second common electrode.

12. The liquid crystal display of claim 11, wherein:
the fifth subpixel electrode and the sixth subpixel electrode are connected to each other, and
the seventh subpixel electrode and the eighth subpixel electrode are connected to each other.

13. The liquid crystal display of claim 11, wherein:
the second voltage is higher than the first voltage,
the data voltage having a positive polarity is applied to the first pixel electrode and the fourth pixel electrode, and the data voltage having a negative polarity is applied to the second pixel electrode and the third pixel electrode.

14. The liquid crystal display of claim 11, wherein:
the first voltage and the second voltage are alternately applied to the first common electrode and the second common electrode,
the second voltage is applied to the second common electrode when the first voltage is applied to the first common electrode, and
the first voltage is applied to the second common electrode when the second voltage is applied to the first common electrode.

15. The liquid crystal display of claim 14, wherein:
the second voltage is higher than the first voltage,
when the first voltage is applied to the first common electrode and the second voltage is applied to the second common electrode,
the data voltage having a positive polarity is applied to the first pixel electrode and the fourth pixel electrode, and the data voltage having a negative polarity is applied to the second pixel electrode and the third pixel electrode.

16. The liquid crystal display of claim 15, wherein:
when the second voltage is applied to the first common electrode and the first voltage is applied to the second common electrode,
the data voltage having a negative polarity is applied to the first pixel electrode and the fourth pixel electrode, and the data voltage having a positive polarity is applied to the second pixel electrode and the third pixel electrode.

17. The liquid crystal display of claim 1, further comprising:
a first common electrode line and a second common electrode line disposed on the substrate,
the first common electrode line is connected to the first common electrode, and
the second common electrode line is connected to the second common electrode.

18. The liquid crystal display of claim 17, wherein:
the first common electrode line and the second common electrode line are disposed on the same layer as the gate line.

19. The liquid crystal display of claim 1, further comprising:
a roof layer disposed on the first common electrode and the second common electrode, and
an encapsulation layer disposed on the roof layer.

20. The liquid crystal display of claim 19, further comprising:
a plurality of microcavities, of which an upper surface and a side surface are covered by the roof layer and the encapsulation layer, and
the liquid crystal layer is disposed in the plurality of microcavities.
